(19) United States
(12) Patent Application Publication
(10) Pub. No.: US 2006/0129265 A1
(43) Pub. Date: Jun. 15, 2006

(54) Directed defective item repair system and methods

(76) Inventor: Norman Ken Ouchi, San Jose, CA (US)

Correspondence Address: NORMAN KEN OUCHI, P.O. BOX 20111, SAN JOSE, CA, 95160, US

(21) Appl. No.: 11/009,650

(22) Filed: Dec. 11, 2004

(51) Int. Cl. G06F 19/00

(52) U.S. Cl. 700/110; 705/8; 700/105

(57) ABSTRACT

The field of the present invention is the repair of a defective item where the item is directed through the repair process by a system. In the present invention, a manufacturing execution system controls and tracks an item through a sequence of workcenters that implement a process. A route defines the sequence of work centers for the process without repairing a defective item. An item is tested at a test workcenter and fails. A defect symptom describes the defect. A quality information screen collects quality information for the defect and presents a list of repair workcenters. Based on the defect symptom description, a repair workcenter is selected. The manufacturing execution system suspends the route and directs the item to the repair workcenter. The item is repaired at the repair workcenter and the quality information screen presents a list of workcenters including the test workcenter. If the repair of the item is complete, the test workcenter is selected. The manufacturing execution system directs the item to the test workcenter. The test workcenter tests the item. When the item passes the test, the route is resumed and the item is directed to the workcenter in the route after the test workcenter. If the repair is not complete, the repair workcenter selects the workcenter to continue the repair and the manufacturing execution system directs the item to the selected workcenter.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

The field of the present invention is the repair of a defective item where the item is directed through the repair process by a system.

### BRIEF SUMMARY OF THE INVENTION

In the present invention, a manufacturing execution system controls and tracks an item through a sequence of workcenters that implement a process. A route defines the sequence of work centers for the process without repairing a defective item. An item is tested at a test workcenter and fails. A defect symptom describes the defect. A quality information screen collects quality information for the defect and presents a list of repair workcenters. Based on the defect symptom description, a repair workcenter is selected. The manufacturing execution system suspends the route and directs the item to the repair workcenter. The item is repaired at the repair workcenter and the quality information screen presents a list of workcenters including the test workcenter. If the repair of the item is complete, the test workcenter is selected. The manufacturing execution system directs the item to the test workcenter. The test workcenter tests the item. When the item passes the test, the route is resumed and the item is directed to the workcenter in the route after the test workcenter. If the repair is not complete, the repair workcenter selects the workcenter to continue the repair and the manufacturing execution system directs the item to the selected workcenter.

### BACKGROUND OF THE INVENTION

A manufacturing execution system, MES, directs the flow an item through a sequence of workcenters to implement a process for the item. The process may the manufacture of the item. The sequence of workcenters is derived from a route, a step-by-step description of the process. Most routes are linear without branches or loops since linear routes supports most processes. FIG. 1 illustrates a route with the sequence: Workcenter 1, Workcenter 2, and Workcenter 3. However, if an item fails a test workcenter and the item is to be repaired, the route to repair an item can be very complex. Some MES support routes with conditional branching and loops. Even with these advanced MES, only simple repair processes may be supported. FIG. 2 illustrates a route where Test Workcenter 2 is a test workcenter. If the item passes at Test Workcenter 2, the item is directed to Workcenter 3. If an item fails, the conditional branch in the route directs the item to Repair Workcenter 1. After the item is repaired, the item is directed back to Test Workcenter 2. If the item passes, the item is directed to Workcenter 3. Note that these simple functions required the MES to support both a conditional branch and a loop capability. More complex repair processes require significant effort to develop and debug. High value products or high volume products may have routes to support the repair processes since the effort to develop the repair route maybe recovered with more effective repair. FIG. 3 illustrates a route with three repair work centers. For one set of defects the item is directed to Repair Workcenter 1 as illustrated with the directed line A. For a second set of defects the item is directed to Repair Workcenter 2 as illustrated with the directed line B. At Repair Workcenter 2, depending on the result of another condition, the item is directed to Repair Workcenter 3 as illustrated with the directed line C or the item is directed to Repair Workcenter 1 as illustrated with the directed line D. For this relatively simple repair, the route structure and branching can be quite complex and the development of the repair route error prone.

In the electronics industry, contract manufacturers, third parties that specialize in manufacturing electronic products, manufacture many of the products. Contract manufacturers manufacture hundreds or thousands of different products and cannot make large investments in tailoring their MES routes for the wide variety of products. Many contract manufacturers create the linear route for the product and depend on their employees to direct items that fail to the correct sequence of repair work centers. The lack of control by the MES for items with defects can result in a “walk around” where an item is though to be repaired and directed to the workcenter next in sequence after the test workcenter and shipped with the defect. The MES of some contract manufacturers is designed so that if an item fails, it may be directed to any workcenter but must return to the workcenter at which it failed and pass before it continues on the route. This avoids the “walk around” problem. However, in both cases, the MES cannot track the item under repair. The MES might track where the item is but cannot direct where it should go for the next repair process step. Item can become lost since the sending workcenter and receiving workcenter are not known. The repair process depends on the experience of the operators to determine what should be done next. The experience of the organization cannot be embodied in the MES to improve the process. The work in process (WIP) report is used to track the progress of a group of items. The prior art MES do not easily distinguish items without defects from items with defects in the WIP reports. Some prior art MES cannot show items in repair workcenters.

What is desired is a directed defective item repair where
1. Repair routes are easily created and maintained
2. The item is directed by the MES—the sender and receiver are known and tracked
3. The experience of the organization can be applied to select the repair process route.
4. Repair route are easy for the operators to use by minimizing actions for frequent events
5. The work in process (WIP) reports provide information on the items in the repair process

### BRIEF DESCRIPTION OF DRAWINGS

FIG. 1 illustrates a linear route.

FIG. 2 illustrates a route with repair capabilities to direct an item to a repair workcenter and return to the test workcenter to validate the repair.

FIG. 3 illustrates a route with repair capabilities to direct an item to a set of repair workcenters.

FIG. 4 illustrates a route where the repair is not directed.

FIG. 5A illustrates a route where in the repair process, the first route segment X is selected for a directed repair.

FIG. 5B illustrates the second step of the repair process where the second route segment Y is selected for the directed repair.

FIG. 5C illustrates the third step of the repair process where the third route segment Z is selected for the directed repair.

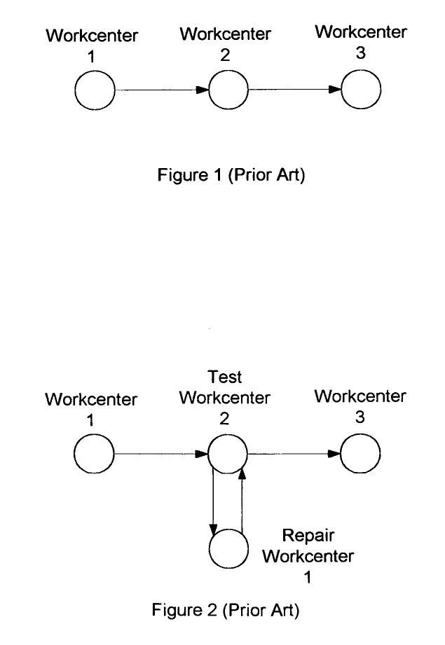

### DESCRIPTION OF THE INVENTION

The directed defect repair system uses linear routes for the non-defective item process. In the normal state, the item is directed to a workcenter specified in the route. If the item is selected at a workcenter other than the directed workcenter, the prior art MES displays an error message directing the item to the directed workcenter.

In the present invention, when an item fails, the route is suspended for the item and the item is set to a repair state. The workcenter terminal displays a quality data collection screen where information about the defect is collected. At the test workcenter, information describing the defect symptom is collected. For consistency and accuracy, the defect symptom description includes a defect symptom code. The defect symptom code is a number or short text string assigned to the defect symptom so that all information related to instances of the defect symptom can be systematically found. Workcenter operators are provided with a reference table from which the operator can select the defect symptom code matching the observed defect symptom. In an advanced prior art MES, the system provides the reference table. For automated test systems integrated with a prior art MES, the automated test system may provide the defect symptom code without operator intervention.

In the present invention, the quality collection screen also presents a list of repair workcenters. A repair workcenter is selected based on the defect symptom. When the defect symptom information collection is completed, the MES directs the item to the selected repair workcenter. Each item has a unique identifier such as a barcode that is used by the MES to control and track the item. When the identifier for the item is read at the selected repair workcenter, the quality collection screen is displayed. A repair code can be entered. A list of repair workcenters including the test workcenter is presented. If the repair is completed, the test workcenter is selected and the item is directed back to the test workcenter. If the test is successful at the test workcenter, the route is resumed and the item is directed to move to the next workcenter in the route. If the repair is not complete, another repair workcenter is selected and the item is directed to the selected repair workcenter.

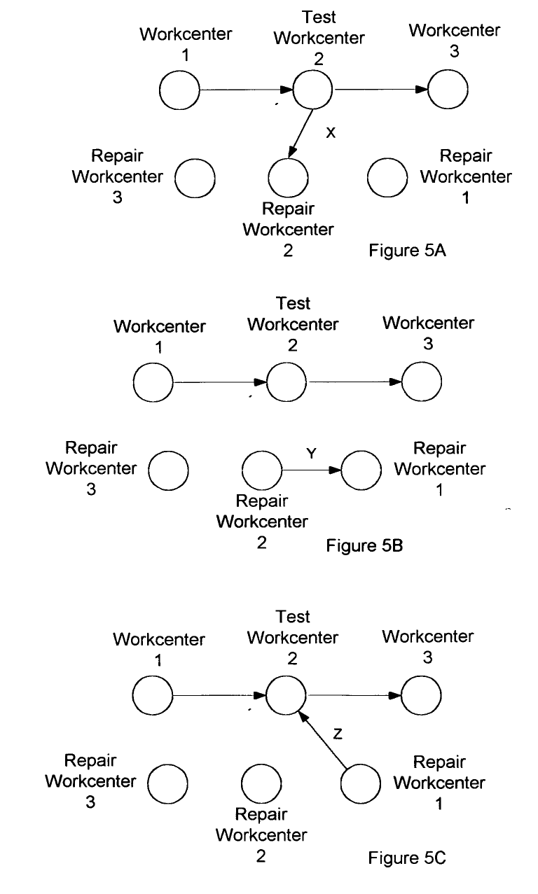

FIG. 5A illustrates an item failing a test at Test Workcenter 2. A list of repair workcenters is presented on the quality collection screen. The list includes Repair Workcenter 1, Repair Workcenter 2, and Repair Workcenter 3. For the example, based on the defect symptom, Repair Workcenter 2 is selected and the item is directed to move to Repair Workcenter 2. This is illustrated as directed line X. FIG. 5B illustrates the item at Repair Workcenter 2. A list of repair workcenters including the workcenter where the item failed is presented. The repair is not complete and Repair Workcenter 1 is selected and the item is directed to move to Repair Workcenter 1. This is illustrated as directed line Y. FIG. 5C illustrates the item at Repair Workcenter 1. A list of repair workcenters including Test Workcenter 2, where the item failed, is presented. The repair is completed; Test Workcenter 2 is selected and the item is directed to Test Workcenter 2. This is illustrated as directed line Z. If the item passes the test at Test Workcenter 2, the route is resumed and the item is directed to move to Workcenter 3.

The experience of the organization can be used to aid in selecting the repair workcenter. A test workcenter will test specific capabilities of the item. All defect symptoms will not be uncovered at a given test workcenter. A subset of defect symptoms can be selected to be the more likely defect symptoms. Similarly, a subset of repair workcenters are the likely repair workcenters selected for a given test workcenter. The selection list is a multi-way branch where the selection is based on the defect symptom. The list at each workcenter may be different to reflect the role each workcenter plays in the repair process and the set of successor workcenters in the repair process.

The selection list is designed such that the first entry in the list is selected if another entry is not selected. The first entry is the default repair workcenter. At the each test workcenter, a subset of the repair workcenters are selected based on the experience of the organization. The most likely repair workcenter is placed at the top of the list and is the default repair workcenter. At each repair workcenter, the workcenter that failed the item is selected to be the default workcenter.

A manufacturing line may assemble items that use two or more different technologies. The defects may be different for each technology. For example in electronics, the components may be connected to the printed circuit board by pins or surface mount. The defects for pin technology are different from those of surface mount. The repair workcenters for pin technology are different from surface mount. The list of repair workcenters can be selected based on technology. When an item has pin technology, the surface mount repair workcenters are not included in the list. The selective pruning of the list reduces the time required for the operators to search to find the repair workcenter for the defect symptom.

In addition, each defect symptom can be assigned a list of repair workcenters. Based on the selection of the defect symptom, the repair workcenter list can be selected by the MES. This requires that each defect symptom be manually assigned a repair workcenter list. This assignment is done once. For products that have long production runs, the investment may be of value. In most cases, the test technicians know the association of defect symptoms and can select the appropriate repair workcenter from a pruned list. The present invention will operate with either a manual association or an automated association.

The selection need not be limited to a workcenter. A route segment, a sequence of workcenters, can be selected The MES directs the item through the sequence of workcenters. At the end of the route segment, the MES provides the ability to select from the list of workcenters including the workcenter that failed the item.

The MES provides work in process (WIP) reports show all items in the route by workcenter with the quantity good and quantity in the repair process. The MES provides a report displaying each item in the repair process and the repair workcenter.

An item can “loop” in the repair process where the item fails again at the test workcenter and directed again to a repair workcenter. This may occur several times. After repeated repair attempts, it may be more economical to scrap the item and start the assembly of another item. The present invention provides a loop count that is incremented each time an item fails at a test workcenter.

The present invention provides
1. Simple routes used for the defect free process. The route is suspended when a defect in an item is detected and repaired. The repair routes are not created with the defect free process but created when an item fails by selecting the next workcenter based on the symptoms of the defect in the item.
2. The item movement is system directed during the repair process. The repair workcenter is selected based on the defect symptom. The sending and receiving workcenters are known so the item is less likely to “get lost”.
3. The experience of the organization can embodied in the workcenter selection lists for each workcenter. The selection lists are multi-way branches at each workcenter where the branch selection is based on the defect symptom.
4. The default workcenter at the top of the selection list minimizes the transactions required by the operator by removing the need to pull down the list and search for the repair workcenter to select. The operator need only enter the defect symptom code and submit the transaction.
5. Work in process (WIP) reports with quantity good and quantity in the repair process. Also provides a loop counter to detect items that have had repeated number of repair attempts.

### DESCRIPTION of a PREFERRED EMBODIMENT

A route can be embodied as a relational database table. Table 1 illustrates a table and data for the linear route of FIGS. 4, 5A, 5B, and 5C.

TABLE 1
Route Table

| Route name | Current | Next | Workcenter |
|---|---|---|---|
| Route 1 | Start | 2 | Workcenter 1 |
| Route 1 | 2 | 3 | Test Workcenter 2 |
| Route 1 | 3 | End | Workcenter 3 |

In Table 1, the route name field permits multiple routes to be embodied in the Route Table. The Current field designates a node in the route. “Start” in the Current field indicates the beginning node of the route. The Next field designates the next node in the route. The “2” in the Next field of the first row of the table indicates that the row with the Current field containing “2” is the node that follows the beginning node. The value “End” in the Next field of a row indicates the end of the route. The Workcenter Field indicates the workcenter for the node.

An item following a route is represented in Table 2A.

TABLE 2A
Item Table

| Identifier | Route Name | Current | Workcenter |
|---|---|---|---|
| 12345 | Route 1 | 2 | Test Workcenter 2 |

Each item has an identifier such as a barcode. The Identifier field carries the item identifier. For the item with Identifier “12345”, the Route Name is “Route 1” and is at the node “2” which has the Test Workcenter 2 as the workcenter. The prior art manufacturing execution system, MES, has a component that is a workflow program that uses the Item Table and the Route Table to track and direct the movement of an item. When the item in Table 2A with identifier “12345” is selected, the prior art MES workflow queries the Item Table to locate the row with “12345” in the Identifier field. From the row, the prior art MES determines that the item is following the route with “Route 1” in the Route Name field, that it is at the node with “2” in the Current Field, and that is should be at Test Workcenter 2. If the item passes the test at Test Workcenter 2, the prior art MES workflow queries the Route Table with Route Name=“Route 1” and Current=“2”. The result of the query returns the row where the Next field=“3”. The prior art MES workflow queries the Route Table with Route=“Route 1” and Current=“3”. The result of the query returns the row where the Workcenter=“Workcenter 3”. Table 2B illustrates the Item Table after the item is directed to move to Workcenter 3.

TABLE 2B
Item Table

| Identifier | Route Name | Current | Workcenter |
|---|---|---|---|
| 12345 | Route 1 | 3 | Workcenter 3 |

The prior art MES workflow expects the item to be at Workcenter 3. If the item with Identifier 12345 were selected at another workcenter, the MES workflow would signify an error and direct that the item should be at Workcenter 3.

The MES workflow of the present invention performs for an item without a defect the same functions as the prior art MES workflow. For present invention, the Item Table is extended with a Failed Workcenter field as illustrated in Table 3A

TABLE 3A
Item Table

| | Route | Cur- | | |
|---|---|---|---|---|
| Identifier | Name | rent | Workcenter | Failed Workcenter |
| 12345 | Route 1 | 2 | Test Workcenter 2 | None |

The Failed Workcenter field is used when an item is in the repair process and contains the workcenter at which the item failed. The failed workcenter is where the item must return to be retested after the repair has been completed. When the Failed Workcenter field contains the value “None” the MES workflow processes the selection of an item as in the prior art MES workflow.

In FIG. 5A, an item was failed at Test Workcenter 2. For the example, the item with identifier 12345 following Route 1 failed the test at Test Workcenter 2. Table 3B illustrates the Item Table row when the item is failed.

TABLE 3B
Item Table

| | Route | Cur- | | |
|---|---|---|---|---|
| Identifier | Name | rent | Workcenter | Failed Workcenter |
| 12345 | Route 1 | 2 | Test Workcenter 2 | Test Workcenter 2 |

The Failed Workcenter field is assigned the name of the workcenter at which the item failed, “Test Workcenter 2”. The quality information collection screen provides a list of repair workcenters and Repair Workcenter 2 is selected.

The list of repair centers can contain the experience of the organization so that only repair workcenters relevant to a test workcenter is presented. The list of repair workcenters is a table (not illustrated) that has two fields, Test Workcenter Name and Repair Workcenter Name. For Test Workcenter 2, this table contains three rows where the Test Workcenter Name field contains “Test Workcenter 2” and for the first row the Repair Workcenter Name fields contains “Repair Workcenter 1”; second row contains “Repair Workcenter 2”; third row contains “Repair Workcenter 3”. Each test workcenter can have a different list. The list of repair centers can contain a third field that contains the ranking of the row such that the sequence of the list can be controlled so that the list of repair work centers has the repair workcenters related to the more frequent defect symptoms are presented near the top of the list. The repair workcenter at the top the list is the default repair workcenter and is selected if another repair workcenter is not selected.

The Item Table can be queried for rows where the Failed Workcenter field is not “None” to return all items that are in a repair process. The repair workcenter and the test workcenter at which the item failed can be displayed.

The Work In Process report queries the workcenters in the sequence of the route to display the quantity of items at each workcenter. This report is used to display the progress of a group of items in the manufacturing process. Items that do not have “None” in the Failed Workcenter field can be displayed as items in repair. These items may take longer to complete than items that do not have defects. Some items in repair may not be repaired and may not complete. Accurate information on items with defects provides better data on which to predict the completion of the group of items.

Table 3C illustrates the Item Table row after Repair Workcenter 2 is selected as the repair workcenter.

TABLE 3C
Item Table

| | Route | Cur- | | |
|---|---|---|---|---|
| Identifier | Name | rent | Workcenter | Failed Workcenter |
| 12345 | Route 1 | 2 | Repair Workcenter 2 | Test Workcenter 2 |

The MES workflow for the present invention directs the item with 12345 identifier to be moved to Repair Workcenter 2. At Repair Workcenter 2, the MES workflow for the present invention determines that the Failed Workcenter field in not “None” and presents the screen to collect quality information and the list of repair workcenters. The workcenter name in the Failed Workcenter field is included at the top of the list of repair workcenters from which to select the next workcenter. In the example, the repair is not complete and the item is directed to move to Repair Workcenter 1. The row for the item in the Item table is illustrated in Table 3D

TABLE 3D
Item Table

| | Route | Cur- | | |
|---|---|---|---|---|
| Identifier | Name | rent | Workcenter | Failed Workcenter |
| 12345 | Route 1 | 2 | Repair Workcenter 1 | Test Workcenter 2 |

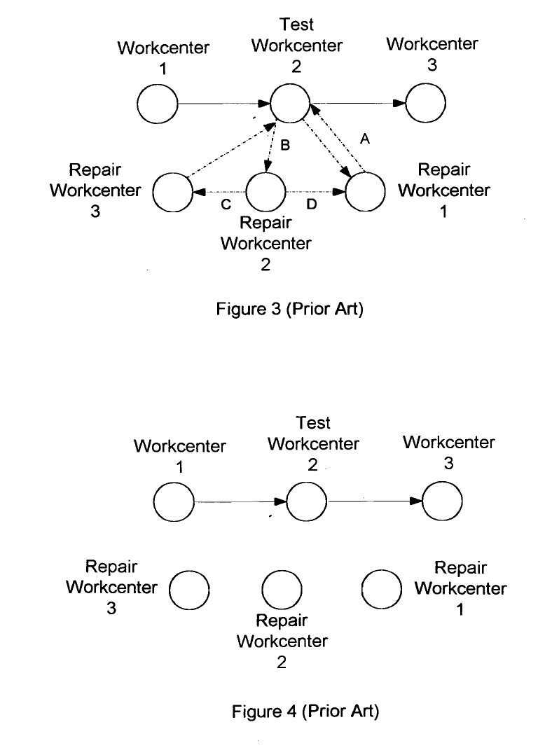

When the repair is complete, the item is directed to move back to the workcenter at which it was failed. This is illustrated in FIG. 3E

TABLE 3E
Item Table

| | Route | Cur- | | |
|---|---|---|---|---|
| Identifier | Name | rent | Workcenter | Failed Workcenter |
| 12345 | Route 1 | 2 | Test Workcenter 2 | Test Workcenter 2 |

When the item is tested at Test Workcenter 2, the MES workflow for the present invention determines that the Workcenter field and Failed Workcenter fields are equal and presents the Pass or Fail selection. If the item fails again, the repair workcenter list is presented and the process as describe is used. The same workcenter need not be selected and a different directed repair may be processed. If the item passes, the MES workflow for the present invention, processes the table information as described for the prior art MES workflow, directs the item to Workcenter 3, and sets the Failed Workcenter field to “None”. Table 4 illustrates the Item Table with a failure loop counter field with the value after the first failure at Test Workcenter 2. The field named Loop contains the number of times an item has failed. It is initially 0 and set to 0 when the item passes at a test workcenter. The Loop field is incremented each time the item fails at a test work center.

TABLE 4
Item Table

| | Route | | | Failed | |
|---|---|---|---|---|---|
| Identifier | Name | Current | Workcenter | Workcenter | Loop |
| 12345 | Route 1 | 2 | Repair | Test | 1 |
| | | | Workcenter 2 | Workcenter 2 | |

Table 5 illustrates the Item Table with a From field with the name of the sending workcenter in a repair route. The MES of the present invention inserts the value in the Workcenter field when the item is directed to move to another workcenter. Table 5 illustrates the values after the item failed at Test Workcenter 2 and is directed to Repair Workcenter 2.

TABLE 5
Item Table

| | Route | | | Failed | | |
|---|---|---|---|---|---|---|
| Identifier | Name | Current | Workcenter | Workcenter | Loop | From |
| 12345 | Route 1 | 2 | Repair | Test | 1 | Test |
| | | | Workcenter 2 | Workcenter 2 | | Workcenter 2 |

The From field provides the most recent workcenter for the item should the item be misplaced.

The Repair Workcenter List for each test workcenter can embody the experience of the organization. Table 6 illustrates the Repair Workcenter list such that the technology of the item can select repair workcenter list for a test workcenter.

TABLE 6
Repair Workcenter List Table

| Test Workcenter | Technology | Repair Workcenter |
|---|---|---|
| Test Workcenter 2 | Pin | Repair Workcenter 1 |
| Test Workcenter 2 | Pin | Repair Workcenter 2 |
| Test Workcenter 2 | Surface Mount | Repair Workcenter 1 |
| Test Workcenter 2 | Surface Mount | Repair Workcenter 2 |
| Test Workcenter 2 | Surface Mount | Repair Workcenter 3 |

For the example illustrated in Table 6, for Test Workcenter 2, if the Technology is “Pin”, the repair workcenter list would be Repair Workcenter 1 and Repair Workcenter 2. If the Technology is “Surface Mount” the repair workcenter list would be Repair Workcenter 1, Repair Workcenter 2 and Repair Workcenter 3.

Table 7 illustrates the Repair Workcenter List such that defect symptom can select the repair workcenter list for a test workcenter.

TABLE 7
Repair Workcenter List Table

| Test Workcenter | Defect Symptom | Repair Workcenter |
|---|---|---|
| Test Workcenter 2 | Defect Symptom 1 | Repair Workcenter 1 |
| Test Workcenter 2 | Defect Symptom 2 | Repair Workcenter 1 |
| Test Workcenter 2 | Defect Symptom 2 | Repair Workcenter 3 |
| Test Workcenter 2 | Defect Symptom 3 | Repair Workcenter 2 |
| Test Workcenter 2 | Defect Symptom 3 | Repair Workcenter 3 |

For the example illustrated in Table 7, for Test Workcenter 2, if the defect symptom is “Defect Symptom 1”, Repair Workcenter 1 is presented as the repair workcenter list. For “Defect Symptom 2”, Repair Workcenter 1 and Repair Workcenter 3 are presented as the repair workcenter list. For “Defect Symptom 3”, Repair Workcenter 2 and Repair Workcenter 3 are presented as the repair workcenter list.

The repair process may require a sequence of workcenters to repair the defect. At a test failure, the test workcenter can select a route segment. Table 8 illustrates a route segment. Note that the structure is the same as a route and can use the Route Table.

TABLE 7
Route Table for a Route Segment

| Route name | Current | Next | Workcenter |
|---|---|---|---|
| Repair Route A | Start | 2 | Repair Workcenter 2 |
| Repair Route A | 2 | End | Repair Workcenter 1 |

The Item Table has two added fields to process the repair Route and is illustrated in Table 8.

TABLE 8
Item Table with Repair Route

| | Route | | | | | Repair |
|---|---|---|---|---|---|---|
| Identifier | Name | Current | Workcenter | Failed Workcenter | Repair Route | Current |
| 12345 | Route 1 | 2 | Repair Workcenter 2 | Test Workcenter 2 | Repair Route A | Start |

At Test Workcenter 2, Repair Route A is selected. The MES workflow for the present invention uses the Repair Route field for the repair route segment and Repair Current field to track the location of the item, and the Workcenter field for the workcenter to which the item is directed. The data in Table 8 illustrates the item with identifier “12345” which failed the test at Test Workcenter 2 and is directed to Repair Workcenter 2. When the MES workflow for the present invention detects the end of the route segment where Next=“End”, the quality information collection screen is displayed. The item can be directed to the workcenter at which it failed, Test Workcenter 2, or to another repair workcenter.

For the present invention, the route for the defect free process can be a simple linear route. The directed repair route is dynamically created starting with the test workcenter at which the defect symptom is used to select the repair workcenter from a list of repair workcenters. The defect free route is suspended and the item is directed to the selected workcenter. When the repair at the selected workcenter is complete, a list of repair workcenters and the test workcenter at which the item failed is presented. If the item has been repaired, the test workcenter is selected. If the item passes the test at the test workcenter, the item resumes the defect free process

If the item has not completed the repair process, a second repair workcenter is selected. The item is directed to the second repair workcenter. When the item is repaired, the test workcenter is selected and the process continues as described above.

The experience of the organization can be embodied in the lists of repair centers such that the list presents repair workcenters pertinent to the expected defect symptoms at a specific test workcenter. The repair workcenter list can also depend on the technology from which the item is assembled. The repair workcenter list can also depend on the defect symptom. The item tracking information can include the sending workcenter so that both sending and receiving workcenters are identified for tracking in the repair process. The item tracking information can include the number of times the item failed at a test workcenter. The number of failures may be used in a decision to scrap the item rather than repair it. A repair route segment, a sequence of workcenters, may be selected as part of the repair process.

With the present invention, complex repair routes need not be developed. The item is directed from workcenter to workcenter in the repair process by selecting the next workcenter in the repair process based on the defect symptom.

The MES and MES workflow are implemented as software programs written in Java, C++, Microsoft Visual Basic, or a number of programming languages. The programs may use a database for storing translation tables and other information. Database programs are available from Oracle, IBM, Microsoft, and many other providers. These programs and databases execute in computers manufactured by, for example, IBM, Sun, Dell, and Compaq. The computers may be, for example, PC's, workstations, mainframes, and hand-held computers. The computers may have an operating system such as UNIX, LINUX, Microsoft 2000, and IBM OS/9000. The computer is connected to a network that may be, for example, a LAN, WAN, Internet, Intranet, wireless LAN, or wireless Internet.

Those skilled in the art may implement these functions in other ways and not limited to this description.

I claim:

1. An adaptive repair system comprising:
a manufacturing execution system with a route,
an item with a defect described by a first defect symptom,
a first test work center,
a first repair work center;
the defect in the item discovered at the first test work center where the adaptive repair system includes the steps
the first repair work center is associated with the first defect symptom
the first repair work center is selected based on association with the first defect symptom
the manufacturing execution system suspends the route and directs the item to the first repair work center
the first repair work center repairs the defect and selects the first test workcenter
the manufacturing execution system directs the item to the first test work center
the first test work center retests the item
the manufacturing execution system resumes the route when the item passes the test at the first test work center.

2. The adaptive repair system of claim 1,
the first repair work center does not repair the item
a second repair workcenter;
the defect is described by a second defect symptom,
where the adaptive repair system further includes the steps
the second repair work center is associated with the second defect symptom
the second repair work center is selected based on the second defect symptom
the manufacturing execution system directs the item to the second repair work center
the second repair workcenter repairs the defect and selects the first test workcenter
the manufacturing execution system directs the item to the first test work center
the first test work center retests the item
the manufacturing execution system resumes the route when the item passes the test at the first test work center.

3. The adaptive repair system of claim 1 and a third defect symptom where the first repair workcenter is associated with the third defect symptom such that the first repair workcenter can be selected when an item with a defect described by the third defect symptom is repaired.

4. The adaptive repair system of claim 1 further provides a default repair workcenter; wherein the default repair workcenter is selected without the additional selection steps as required to select other repair workcenters.

5. The adaptive repair system of claim 1 and a technology class, where
the item is classified as a member of the technology class and
the first repair work center is further associated with the technology class such that the first repair work center can be selected when the item is to be repaired.

6. The adaptive repair system of claim 1 and a fourth defect symptom, where the first workcenter is associated with the fourth defect symptom such that the first workcenter can be selected when the fourth defect symptom is selected.

7. The adaptive repair system of claim 1 provides a work in process (WIP) report where the quantity of items without defects and the quantity of items with defects is displayed.

8. The adaptive repair system of claim 1 provides a defective item report displaying each item with a defect and the workcenter where the item is located.

9. The adaptive repair system of claim 1 provides the workcenter from which an item is sent.

10. The adaptive repair system of claim 1 provides a fail loop counter that is incremented when the item fails at the test workcenter.

11. The adaptive repair system of claim 1 and a route segment, wherein the route segment is selected to repair the item.

12. A method for directing the repair of an item with a defect comprising
a means to direct an item to a workcenter where the sequence of workcenters is specified by a route
a first means to test the item
a first means to repair the item
a first defect symptom describing the defect
where the method includes the steps:
the first means to repair the item is associated with the first defect symptom
the first means to test an item uncovers the defect
the first means to repair the item is selected based on the association with the first defect symptom
the means to direct an item to a work center suspends the route and directs the item to the first means to repair the item
the item is repaired at the first means to repair the item and the first means to test the item is selected
the means to direct an item to a workcenter directs the item to the first means to test the item
the item is tested at the means to test the item and
when the item passes the test, the means to direct an item to a workcenter resumes the route and directs the item to the next workcenter in the route

13. The method for directing the repair of an item with a defect of claim 12,
a second means to repair the item,
a second defect described by a second defect symptom
where
the second means to repair the item is related to the second defect symptom,
the first means to repair the item uncovers the second defect and selects the second means to repair the item,
the means to direct an item to a workcenter directs the item to the second means to repair the item,
the second means to repair the item repairs the item and selects the means to test the item,
the item is tested at the means to test the item,
when the item passes the test, the means to direct an item to a workcenter resumes the route and directs the item to the next workcenter in the route

14. The method for directing the repair of an item with a defect of claim 12 further provides a default means to repair the item that is selected without added selection steps.

15. The method for directing the repair of an item with a defect of claim 12 further provides a means for determining the workcenter from which the item is to be moved.

16. The method for directing the repair of an item with a defect of claim 12 further provides a work in process report displaying the quantity of non-defective units and defective units at each workcenter.

17. A quality information collection screen displaying a list of workcenters,
a manufacturing execution system (MES) workflow program with a route
a first repair work center
a first test work center
an item with a defect described by a first defect symptom is tested at the first test workcenter
where
the first defect symptom is associated with the first repair workcenter
the MES workflow program suspends the route and presents the quality information screen
the quality information screen presents a list of workcenters including the first repair workcenter.
the first repair workcenter is selected based on the association with the first defect symptom
the MES workflow program directs the item to the first repair workcenter
the first repair workcenter repairs the defect
the MES workflow program presents the quality information screen
the quality information screen presents a list of workcenters including the first test workcenter.
The first test workcenter is selected based on fixing the defect
the MES workflow program directs the item to the first test workcenter
the test workcenter tests the item
the MES workflow program resumes the route when the item passes the test at the first test workcenter

18. The quality information collection screen displaying a list of workcenters of claim 17 wherein
the first workcenter is related to a technology,
the item is related to the technology,
the list of workcenters includes the first workcenter related to the technology

19. The quality information collection screen displaying a list of workcenters of claim 17 wherein
the first workcenter is related to the first defect symptom,
the defect is described by the first defect symptom,
the list of workcenters includes the first workcenter related to the first defect symptom

20. The quality information collection screen displaying a list of workcenters of claim 16 wherein the list of workcenters provides a default workcenter that is selected without additional selection steps.
